(19) United States
(12) Patent Application Publication
(10) Pub. No.: US 2025/0273063 A1
(43) Pub. Date: Aug. 28, 2025

(54) ALERT SYSTEM AND METHOD THEREOF

(71) Applicant: GM Global Technology Operations LLC, Detroit, MI (US)

(72) Inventors: Mitchell C. Thumme, South Lyon, MI (US); Alex Jose Veloso, Rochester Hills, MI (US); Aaron Adler, Rochester Hills, MI (US)

(73) Assignee: GM Global Technology Operations LLC, Detroit, MI (US)

(21) Appl. No.: 18/586,503

(22) Filed: Feb. 25, 2024

(51) Int. Cl. G08B 21/18

(52) U.S. Cl. CPC G08B 21/182

(57) ABSTRACT

An alert system for a vehicle includes data processing hardware and memory hardware in communication with the data processing hardware. The memory hardware stores instructions that, when executed on the data processing hardware, cause the data processing hardware to perform operations. The operations include receiving, from a user device, location data, determining, based on the location data, a position of the user device relative to the vehicle, and configuring an electronic control unit (ECU) with a range. The operations also include issuing, based on the position of the user device and the range, a vibration request and executing, based on the issued vibration request, a user alert application of the ECU.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an alert system for a vehicle to support people with hearing assistance devices or distracted users by using vibration on a user device.

Vehicles are typically equipped with audible alerts configured to notify a user of an event related to the vehicle. For example, if a user is not wearing a seatbelt, the vehicle may issue a chime or other audible alert until the seatbelt is fastened. While an audible alert is effective at reminding users of different functions of or related events to the vehicle, persons with hearing impairments may benefit from additional forms of alerts. Vehicles may also prompt, in combination with the audible alert, a text notification on a user interface of the vehicle. While a text notification may be advantageous to a person with hearing impairments, the person may overlook the text notification during the period of time the text notification is displayed. Thus, there is a need for improved alerts and notifications in relation to vehicle notifications.

### SUMMARY

In some aspects, a computer-implemented method when executed by data processing hardware causes the data processing hardware to perform operations. The operations include determining, via location data, a location of a user device relative to a vehicle, identifying, based on positioning data and a vehicle status, a trigger event, and issuing, via a user alert application, a vibration request to the user device. The operations also include receiving, from the user device, a vibration protocol, determining, based on the trigger event and the vibration protocol, an alert level, and executing, based on the alert level, an alert on the user device.

In some examples, the alert level may include a low level, an intermediate level, and a high level, and the vibration protocol may include a single vibration, a multi-vibration, and an extended vibration. The single vibration may correspond to the low level, the multi-vibration may correspond to the intermediate level, and the extended vibration may correspond to the high level. The operations may include executing a calibration protocol and determining, based on the calibration protocol, the distance between a vehicle and the user device. In some instances, determining the location of the user device may include detecting a digital key and matching the detected digital key to a stored digital key profile. In other examples, determining the location of the user device may include determining distance data and identifying a change in the distance data corresponding to the user device. Optionally, the operations may include determining a range corresponding to the distance data of the user device. In some instances, determining the alert level may include comparing the change in the distance data with the determined range.

In other aspects, a system includes data processing hardware and memory hardware in communication with the data processing hardware. The memory hardware stores instructions that, when executed on the data processing hardware, cause the data processing hardware to perform operations. The operations include determining, via location data, a location of a user device relative to a vehicle, identifying, based on positioning data and a vehicle status, a trigger event, and issuing, via a user alert application, a vibration request to the user device. The operations also include receiving, from the user device, a vibration protocol, determining, based on the trigger event and the vibration protocol, an alert level, and executing, based on the alert level, an alert on the user device.

In some examples, the alert level may include a low level, an intermediate level, and a high level, and the vibration protocol may include a single vibration, a multi-vibration, and an extended vibration. The single vibration may correspond to the low level, the multi-vibration may correspond to the intermediate level, and the extended vibration may correspond to the high level. The operations may include executing a calibration protocol including detecting a digital key. In some instances, determining the location of the user device includes matching the detected digital key to a stored digital key profile. In other instances, determining the location of the user device includes determining distance data and identifying a change in the distance data corresponding to the user device. Optionally, the operations may include determining a range corresponding to the distance data of the user device. In further examples, determining the alert level includes comparing the change in the distance data with the determined range.

In further aspects, an alert system for a vehicle includes data processing hardware and memory hardware in communication with the data processing hardware. The memory hardware stores instructions that, when executed on the data processing hardware, cause the data processing hardware to perform operations. The operations include receiving, from a user device, location data, determining, based on the location data, a position of the user device relative to the vehicle, and configuring an electronic control unit (ECU) with a range. The operations also include issuing, based on the position of the user device and the range, a vibration request and executing, based on the issued vibration request, a user alert application of the ECU.

In some examples, the operations may include identifying, via the user alert application, a trigger event and issuing an alert, via the user alert application, in response to the trigger event. Optionally, the operations may include comparing the position of the user device with the configured range, and executing the user alert application includes issuing an alert in response to the comparison of the position of the user device with the configured range. In some instances, the operations may include executing, in response to the issued vibration request, a vibration protocol, the vibration protocol corresponding to the alert.

### BRIEF DESCRIPTION OF THE DRAWINGS

The drawings described herein are for illustrative purposes only of selected configurations and are not intended to limit the scope of the present disclosure.

FIG. 1 is an example schematic of a vehicle with a user walking away from the vehicle with a user device equipped with an alert application according to the present disclosure;

FIG. 2 is an example schematic of a user walking away from a vehicle at different distances, the user wearing a user device equipped with an alert application according to the present disclosure;

FIG. 3 is an example block diagram of an alert system according to the present disclosure;

FIG. 4 is a partial perspective view of an interior of a vehicle equipped with an alert system according to the present disclosure;

FIG. 5 is an example flow diagram for an alert system according to the present disclosure; and

FIG. 6 is another example flow diagram for the alert system of FIG. 5.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

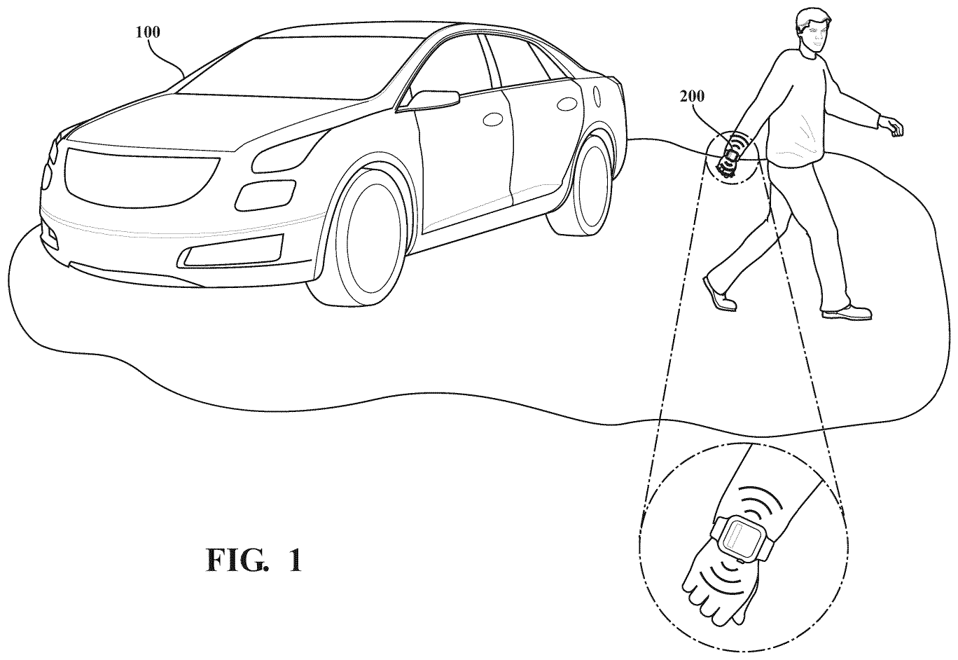

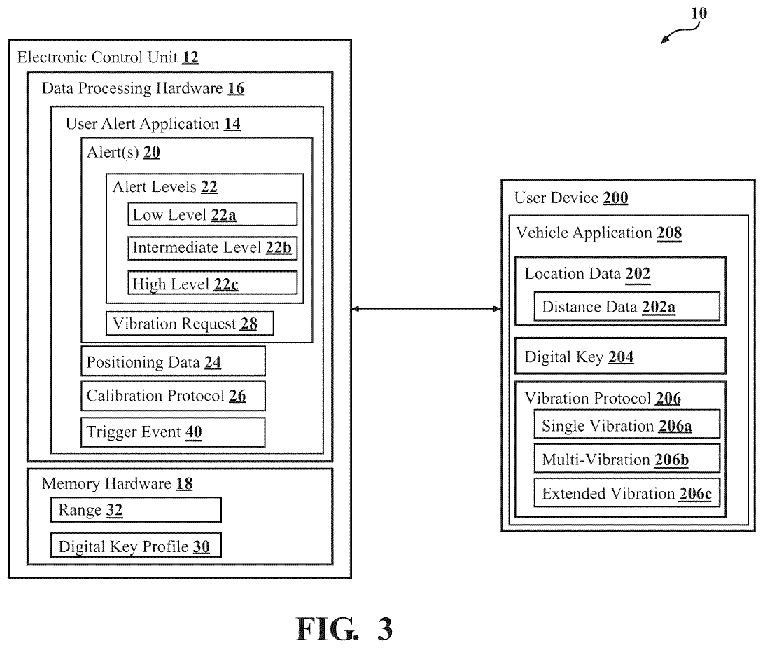

Referring to FIGS. 1-3, an alert system 10 for a vehicle 100 includes an electronic control unit (ECU) 12 of the vehicle and a user device 200 in communication with the ECU 12. The ECU 12 is configured with a user alert application 14, which is executed by data processing hardware 16 of the ECU 12. The ECU 12 also includes memory hardware 18 in communication with the data processing hardware 16. The memory hardware 18 stores instructions that, when executed on the data processing hardware 16, cause the data processing hardware 16, to perform operations described herein. For example, the data processing hardware 16 is configured to execute the user alert application 14 to issue alerts 20 from the user alert application 14 to the user device 200. The alert system 10 is configured to advantageously provide tactile feedback to a user that may or may not utilize hearing assist devices based on a hearing status of the user. Thus, the alert system 10 advantageously provides tactile feedback for the user regardless of the hearing status of the user.

The user alert application 14 is configured to issue the alert 20 or alerts 20 with varying degrees of alert levels 22, such that the user device 200 receives the alert level 22 to support, for example, a hearing amplification device (not shown). For example, the alert levels 22 may include, but are not limited to, a low level 22a, an intermediate level 22b, and a high level 22c. The alert levels 22 may also have a variable range that may capture levels between each of the low, intermediate, and high levels 22a-22c. For example, the alert levels 22 may progressively increase between the different alert levels 22. Each of the alert levels 22 are described in more detail below with respect to the vehicle 100 and the user device 200 and operation of the alert system 10. The ECU 12 is equipped with various short-range wireless communication protocols including, but not limited to, Bluetooth® Low Energy (BLE), and ultra-wide band (UWB). For example, the ECU 12 may detect, via UWB, when a user 210 is positioned within the vehicle 100 and, when the user 210 exits the vehicle 100, may utilize BLE to determine positioning data 24 based on BLE communication with the user device 200.

Further, the ECU 12 may utilize BLE channel sounding (BLE/CS) to measure a distance D₁-Dₙ between the user device 200 and the vehicle 100. Channel sounding (CS) is a subset of Bluetooth® technology that measures a distance between a user device 200 and the equipped CS device (e.g., the ECU 12) by calculating a series of frequencies to estimate a distance D₁-Dₙ between the user device 200 and the ECU 12. Thus, the ECU 12 may utilize CS to estimate location data 202 and, more specifically, distance data 202a of the user device 200. For example, the ECU 12 may use UWB and BLE/CS as a complement in function of a range of each of the UWB and BLE/CS. The distance data 202a is utilized by the user alert application 14 in determining whether to issue an alert 20 and the alert level 22, as described herein. The user alert application 14 utilizes BLE/CS to determine the position of the user 210 and subsequently determine an order of issuing the alerts 20. For example, the user alert application 14 may determine, based on the distance data 202a, a hierarchy of the alert levels 22, such that the alert 20 having the highest priority alert level 22 may be issued at an earlier distance D₁-Dₙ.

In other examples, the ECU 12 may utilize a BLE received signal strength indicator (RSSI), which evaluates the power of the transmission between the user device 200 and the ECU 12. For example, the ECU 12 may utilize a combination of UWB and BLE RSSI in determining a signal strength of the user device 200 and, thus, to estimate the distance data 202a by utilizing a complement in function of a range of each of the UWB and BLE RSSI, respectively. In yet another example, the ECU 12 may utilize a combination of UWB and Wi-Fi® round trip wave time to estimate the distance data 202a. In other examples, the ECU 12 may utilize a combination of UWB, BLE RSSI, and CS and/or a combination of UWB, BLE RSSI, CS, and Wi-Fi® round trip wave time to estimate the distance data 202a. In these examples, the UWB provides a high accuracy estimation at a short range, while each of BLE/CS, BLE RSSI, and/or Wi-Fi® round trip wave time each provides an intermediate accuracy estimation at long range. Further, each of the above combinations of UWB, BLE/CS, BLE RSSI, and/or Wi-Fi® round trip wave time may be calibrated as part of the alert system 10.

Referring still to FIGS. 1-3, the memory hardware 18 may store a digital key profile 30 that corresponds to a digital key 204 of the user device 200. For example, a user 210 pairs the user device 200 with the vehicle 100 via the ECU 12 by setting up the digital key profile 30. In some examples, the user 210 may execute a digital key application on the user device 200 to pair the user device 200, with the digital key 204, to the ECU 12. The user device 200 may include, but is not limited to, a cell phone, a tablet, and/or a smart watch. As depicted, the user device 200 is a smart watch worn by the user 210. However, the user device 200 may be any device capable of receiving information or data from the ECU 12.

Once paired, the user device 200 may send information to and receive information from the ECU 12, including the alerts 20. During the pairing process, the ECU 12 may execute a calibration protocol 26 to calibrate a range 32 corresponding to distances D₁-Dₙ of the user device 200 relative to the ECU 12 and, thus, the vehicle 100. For example, the user alert application 14 may utilize the calibration protocol 26 to set alerts 20 at predetermined range(s) 32. In some examples, the vehicle application 208 may communicate with the user alert application 14 that the user device 200 has moved a first distance D₁ from the vehicle 100, and the user alert application 14 may issue an alert 20 in response.

The distances D₁-Dₙ may include the first distance D₁, a second distance D₂, and a third distance D₃. Similar to the alert levels 22, the distances D₁-D₃ may span a varying degree of distances D₁-Dₙ within the predetermined range 32 stored in the memory hardware 18. Thus, each distance D₁-D₃ may have a respective range 32 that may at least partially overlap with or extend from a previous distance D₁-D₃. With respect to the first distance D₁, the range 32 is determined based on the ECU 12 losing UWB contact with the user device 200 and instead utilizing the BLE/CS to monitor the distance data 202a of the user device 200. The first distance D₁ may overlap with the range 32 in which the ECU 12 may utilize UWB and BLE/CS to minimize a lost connection and maintain tracking of the distance data 202a.

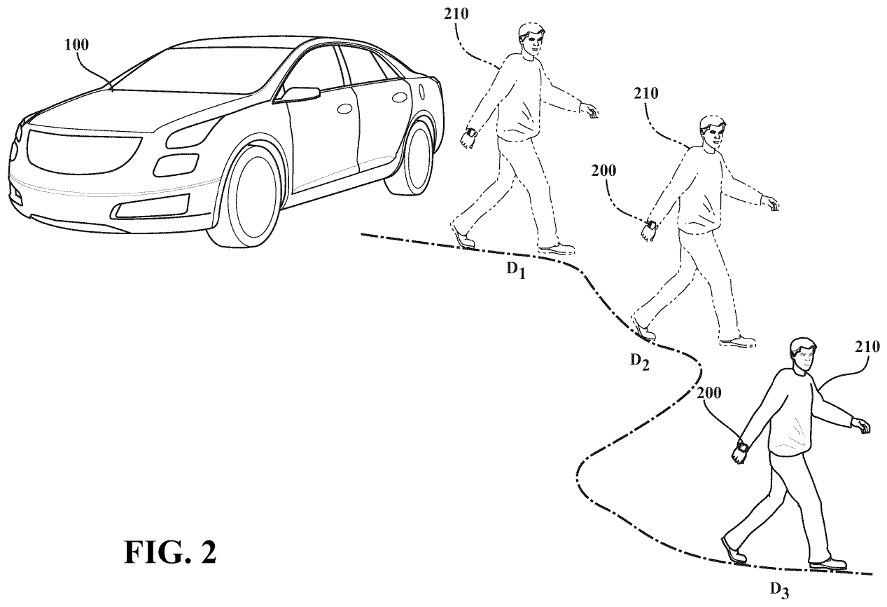

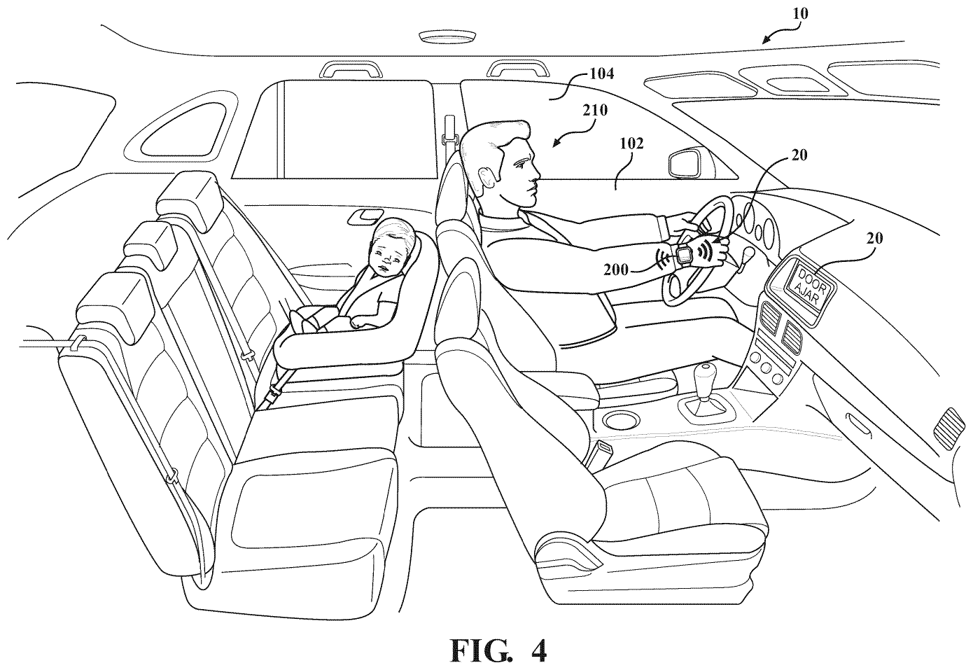

Referring to FIGS. 2-4, the distances D₁-D₃ generally correspond to various trigger events 40 that may occur relative to the vehicle 100. However, it is also contemplated that the trigger events 40 may occur within the vehicle when the ECU 12 is utilizing UWB to monitor the positioning data 24 and/or location data 202 of the user device 200. FIGS. 2-4 generally depict examples of trigger events 40. For example, the user 210 may enter the vehicle 100 and partially close a door 102 of the vehicle 100. Thus, the partially closed door 102 may be a trigger event 40 of the user alert application 14, and the user alert application 14 may issue an alert 20 in response. The user alert application 14 may elevate the alert level 22 based on the duration of the alert 20. For example, if the user 210 does not respond to the alert 20, the user alert application 14 may elevate a low level alert 22a to the intermediate level 22b.

In other examples, lighting of the vehicle 100 may be operational, and the user 210 may exit the vehicle 100. The user alert application 14, in response to receiving the distance data 202a, may issue a low level alert 22a to remind the user 210 that the lighting has remained operational. The user may dismiss the alert 20 and/or may utilize the digital key 204 to cease operation of the lighting. In some instances, the user 210 may leave the digital key 204 or a key fob in the vehicle 100. The user alert application 14 may determine the location data 202 of the user 210 based on the user device 200 and may issue an alert 20 in response. For example, the user may leave a mobile device within the vehicle 100, and the user alert application 14 may issue the alert to a smart watch 200 worn by the user 210. The ECU 12 may track, via the positioning data 24, when the user 210 exits the vehicle 100 by determining that the user device 200 is outside of UWB range. If the user 210 leaves a device equipped with the digital key 204 in the vehicle 100, the user alert application 14 may alert the worn user device 200 (e.g., a smart watch) based on the distance data 202a.

When the user alert application 14 executes the calibration protocol 26, the user alert application 14 calibrates, in addition to the range 32, the alert level 22. The user device 200 may also be configured with a vibration protocol 206, which may be stored as part of a vehicle application 208 on the user device 200. The vehicle application 208 may store and execute the digital key 204 as well as provide the connection with the ECU 12 to receive the location and distance data 202, 202a. The vibration protocol 206 may include, but is not limited to, a single vibration 206a, a multi-vibration 206b, and/or an extended vibration 206c. The vibration protocol 206 may be shared with the user alert application 14 in response to a vibration request 28 issued by the user alert application 14 as part of the alert 20. The vibration protocol 206 provides advantageous assistance to users that utilize hearing aids or other hearing amplification devices. Further, the vibration protocol 206 may assist users that may otherwise intentionally or unintentionally disregard audio or text alerts to further assist in alerting a user regardless of hearing status.

Upon receiving the vibration protocol 206, the user alert application 14 may determine which vibration 206a-206c of the vibration protocol 206 to execute based on the alert level 22. In some examples, the user 210 may configure the vibration protocol 206 to correspond to particular alert levels 22. For example, the single vibration 206a may correspond to the low level 22a, the multi-vibration 206b may correspond to the intermediate level 22b, and the extended vibration 206c may correspond to the high level 22c. However, various applications of the vibration protocol 206 may be utilized, such that each vibration 206a-206c of the vibration protocol 206 may be interchangeably used with the various alert levels 22. In other examples, the user alert application 14, in response to receiving the vibration protocol 206, may set the vibration 206a-206c for each of the alert levels 22.

The user alert application 14 cooperates with the vibration protocol 206 of the user device 200 to vibrate the user device 200 when the user alert application 14 issues an alert 20. The user alert application 14 may determine which vibration 206a-206c to associate with a respective alert level 22 and may communicate the determined vibration 206a-206c with the user device 200. The user device 200 may then execute the corresponding vibration protocol 206 to vibrate the user device 200 in accordance with the alert level 22.

As mentioned above, the user alert application 14 issues the alert 20 in response to one or more trigger events 40. The trigger event 40 may include, but is not limited to, a seat belt reminder, a door being ajar, lighting operations, a vehicle status, window status, roof status, and/or any other event that may trigger or result in a chime or alarm. The user alert application 14 utilizes the combination of the detection of the trigger event 40 and the distance data 202a to determine the alert 20. In some instances, the ECU 12 may determine a change in the distance data 202a corresponding to the user device 200. For example, the first distance D₁ may correspond with approximately ten (10) meters, the second distance D₂ may correspond with approximately twenty (20) meters, and a third distance D₃ may correspond with approximately thirty (30) meters. Each distance D₁-D₃ may be related to an alert level 22 and a specific trigger event 40 determined by the user alert application 14.

In some examples, the first distance D₁ may correspond to trigger events 40 having a high level 22c. For example, if the user 210 leaves the engine operational, the user alert application 14 may issue an alert 20 with a high level 22c corresponding to the extended vibration 206c. Thus, the user alert application 14, in response to determining the trigger event 40 and corresponding alert level 22, issues the vibration request 28 to the user device 200. The vibration request 28, in this example, prompts the user device 200 to execute the extended vibration 206c of the vibration protocol 206.

In other examples, the second distance D₂ may correspond to the door 102 being left ajar or a window 104 left partially or fully open, such that as the user approaches the second distance D₂. the user alert application 14 identifies the trigger event 40. In response, the user alert application 14 may issue the vibration request 28 to the user device 200 including the alert 20 with the intermediate level 22b. In further examples, the third distance D₃ may correspond to lighting remaining operational, as mentioned above. In this example, the user alert application 14 may issue the vibration request 28 including an alert 20 having a low level 22a. The user alert application 14 may customize the vibration 206a-206c based on the alert level 22 by communicating the alert level 22 with the user device 200. Thus, the user alert application 14 may determine the alert level 22 by comparing a change in the distance data 202a with the range 32.

As mentioned above, the user alert application 14 utilizes BLE to communicate the vibration request 28 to the user device 200. For example, the user alert application 14 issues the vibration request 28 using BLE to the vehicle application 208 on the user device 200 requesting execution of the vibration protocol 206. When the user 210 is within the vehicle 100, the ECU 12 may utilize UWB to identify the location data 202 of the user and, as the user 210 exits the vehicle 100, may switch to BLE to monitor the distance data 202a in addition to the location data 202.

To determine that the user 210 is within the vehicle 100, the ECU 12 may utilize a positioning method based on a signal arrival time to estimate the location data 202 of the user 210. For example, the ECU 12 may utilize trilateral ranging using UWB. Once identified, the ECU 12 shares the location data 202 with the user alert application 14 and may issue an alert 20 depending on the position of the user 210 within the vehicle 100. In determining whether the user has exited the vehicle 100, the ECU 12 first may determine whether the user device 200 is outside of the UWB range. If the user device 200 is outside of the UWB range, then the ECU 12 may switch to using BLE/CS by utilizing a phase shift analysis of different tones between a received radio signal and a transmitted radio signal between the ECU 12 and the user device 200.

Depending on the determined location data 202 and/or distance data 202a calculated by the ECU 12, the user may receive a distinguishable vibration 206a-206c corresponding to the alert 20. Thus. The alert system 10 utilizes a hybrid UWB and BLE/CS technique to identify the trigger event(s) 40 and subsequently notify the user via the user alert application 14.

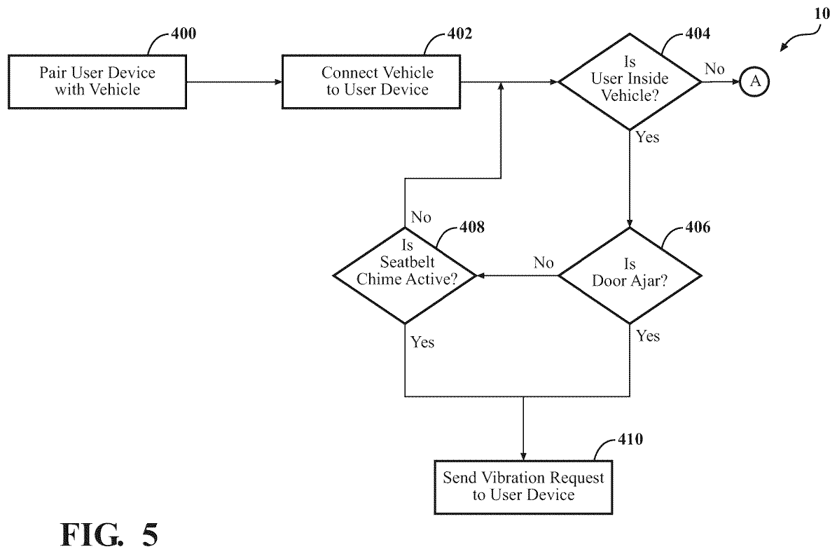

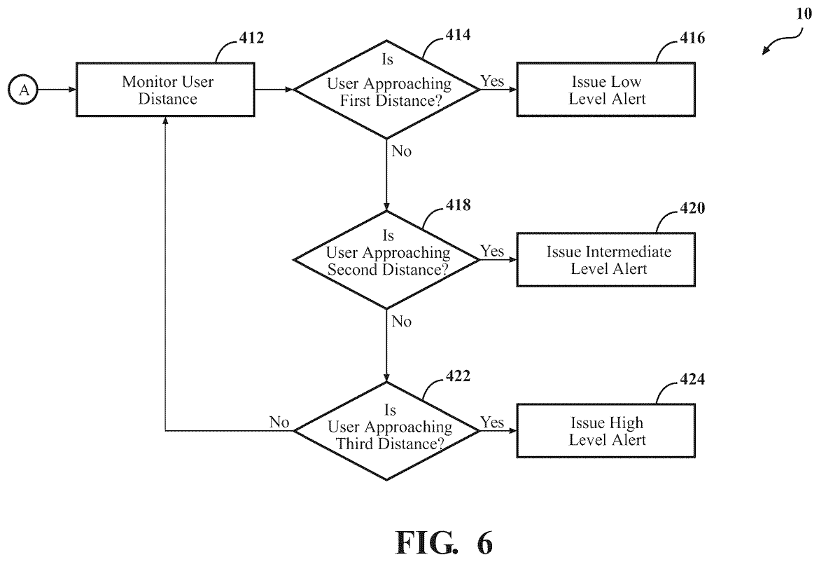

Referring now to FIGS. 5 and 6, an example flow diagram for the alert system 10 is set forth. At step 400, the user device 200 is paired with the ECU 12 of the vehicle 100, and at step 402, the vehicle 100 is connected to the user device 200. The ECU 12 determines, at 404, whether the user 210 is inside the vehicle 100 using a matrix of UWB devices spread out around the vehicle 100. If the user 210 is not inside the vehicle 100, the ECU 12 proceeds as described below with respect to steps 412-424. If the user 210 is inside the vehicle 100, then the ECU 12 determines, at 406, whether a door 102 is ajar. If the door 102 is not ajar, then the ECU 12 determines, at 408, whether a seatbelt chime is active. If the door 102 is not ajar and the seatbelt chime is not active, then the ECU 12 returns to monitor whether the user 210 is inside the vehicle 100. If the door 102 is ajar and/or the seatbelt chime is active, then the ECU 12 executes the user alert application 14 to send the vibration request 28 to the user device 200. While the trigger events 40 described with respect to the flow diagram in FIG. 5 are a door 102 being ajar and/or a seatbelt chime, the trigger event 40 may be any of the trigger events described herein. and the flow diagram for the alert system 10 may proceed accordingly.

As mentioned above, if the user 210 is outside of the vehicle 100, then the ECU 12 monitors, at 412, a distance D₁-D₃ of the user 210 using BLE Channel Sounding. The ECU 12 determines, at 414, whether the user 210 is approaching the first distance D₁. If yes, then the ECU 12 may execute, at 416, the user alert application 14 to issue an alert 20 with a low level 22a. If the user 210 is past the first distance D₁, then the ECU 12 determines, at 418, whether the user 210 is approaching the second distance D₂. If yes, then the ECU 12 may execute, at 420, an alert 20 with the intermediate level 22b. If the user 210 is past the second distance D₂, then ECU 12 may determine, at 422, whether the user 210 is approaching the third distance D₃. If the user 210 is approaching the third distance D₃, then the ECU 12 may execute, at 424, the user alert application 14 to issue an alert 20 with a high level 22c. If the user 210 is not approaching the third distance D₃ or is past, the ECU 12 continues to monitor the distance data 202a.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
determining, via location data, a location of a user device relative to a vehicle;
identifying, based on positioning data and a vehicle status, a trigger event;
issuing, via a user alert application, a vibration request to the user device;
receiving, from the user device, a vibration protocol;
determining, based on the trigger event and the vibration protocol, an alert level; and
executing, based on the alert level, an alert on the user device.

2. The method of claim 1, wherein the alert level includes a low level, an intermediate level, and a high level, and the vibration protocol includes a single vibration, a multi-vibration, and an extended vibration.

3. The method of claim 2, wherein the single vibration corresponds to the low level, the multi-vibration corresponds to the intermediate level, and the extended vibration corresponds to the high level.

4. The method of claim 1, further including executing a calibration protocol and determining, based on the calibration protocol, the distance between a vehicle and the user device.

5. The method of claim 1, wherein determining the location of the user device includes detecting a digital key and matching the detected digital key to a stored digital key profile.

6. The method of claim 1, wherein determining the location of the user device includes determining distance data and identifying a change in the distance data corresponding to the user device.

7. The method of claim 6, further including determining a range corresponding to the distance data of the user device.

8. The method of claim 7, wherein determining the alert level includes comparing the change in the distance data with the determined range.

9. A system comprising:
data processing hardware; and
memory hardware in communication with the data processing hardware, the memory hardware storing instructions that when executed on the data processing hardware cause the data processing hardware to perform operations comprising:
determining, via location data, a location of a user device relative to a vehicle;
identifying, based on positioning data and a vehicle status, a trigger event;
issuing, via a user alert application, a vibration request to the user device;
receiving, from the user device, a vibration protocol;
determining, based on the trigger event and the vibration protocol, an alert level; and
executing, based on the alert level, an alert on the user device.

10. The system of claim 9, wherein the alert level includes a low level, an intermediate level, and a high level, and the vibration protocol includes a single vibration, a multi-vibration, and an extended vibration.

11. The system of claim 10, wherein the single vibration corresponds to the low level, the multi-vibration corresponds to the intermediate level, and the extended vibration corresponds to the high level.

12. The system of claim 9, further including executing a calibration protocol including detecting a digital key.

13. The system of claim 12, wherein determining the location of the user device includes matching the detected digital key to a stored digital key profile.

14. The system of claim 9, wherein determining the location of the user device includes determining distance data and identifying a change in the distance data corresponding to the user device.

15. The system of claim 14, further including determining a range corresponding to the distance data of the user device.

16. The system of claim 15, wherein determining the alert level includes comparing the change in the distance data with the determined range.

17. An alert system for a vehicle, the alert system comprising:
data processing hardware; and
memory hardware in communication with the data processing hardware, the memory hardware storing instructions that when executed on the data processing hardware cause the data processing hardware to perform operations comprising:
receiving, from a user device, location data;
determining, based on the location data, a position of the user device relative to the vehicle;
configuring an electronic control unit (ECU) with a range;
comparing the position of the user device with the configured range and issuing an alert in response to the comparison of the position of the user device with the configured range;
issuing, based on the position of the user device and the range, a vibration request; and
executing, based on the issued vibration request, a user alert application of the ECU.

18. The alert system of claim 17, further including identifying, via the user alert application, a trigger event and issuing an alert, via the user alert application, in response to the trigger event.

19. The alert system of claim 17, further including executing, in response to the issued vibration request, a vibration protocol, the vibration protocol corresponding to the alert.

20. A vehicle incorporating the alert system of claim 17.
